(19) United States
(12) Patent Application Publication
(10) Pub. No.: US 2018/0208878 A1
(43) Pub. Date: Jul. 26, 2018

(54) METHOD FOR THE CARE AND CLEANING OF AN AUTOMATIC DISHWASHER

(71) Applicant: Henkel AG & Co. KGaA, Duesseldorf (DE)

(72) Inventors: Thomas Weber, Marburg (DE); Luca Bellomi, Duesseldorf (DE); Hans Hartumt Janke, Korschenbroich (DE); Volker Blank, Leverkusen (DE); Inga Kerstin Vockenroth, Duesseldorf (DE); Noelle Wrubbel, Duesseldorf (DE); Johannes Zipfel, Duesseldorf (DE); Thomas Paulus, Duesseldorf (DE)

(73) Assignee: Henkel AG & Co. KGaA, Duesseldorf (DE)

(21) Appl. No.: 15/927,265

(22) Filed: Mar. 21, 2018

Related U.S. Application Data
(63) Continuation of application No. PCT/EP2016/072357, filed on Sep. 21, 2016.

(30) Foreign Application Priority Data
Sep. 25, 2015 (DE) 102015218475.7

(51) Int. Cl. C11D 1/72; C11D 3/20; C11D 11/00

(52) U.S. Cl. CPC C11D 1/72; C11D 3/0047; C11D 11/0023; C11D 3/2082

(57) ABSTRACT

A method for the care and cleaning of automatic dishwashers, which eliminates grease and limescale deposits in an automatic dishwasher and which together with an automatic dishwasher detergent is usable in a normal dishwashing cycle. In a normal cleaning cycle for cleaning washware, in particular dirty dishes, using an automatic dishwasher detergent, a care agent for automatic dishwashers that is formulated separately from the dishwasher detergent is added, wherein the care agent contains (a) at least one nonionic surfactant and (b) at least one acid or a buffer system composed of at least one acid and at least one base, and wherein a 10 wt % solution of the care agent in water at 20° C. has a pH of <6.5.

### FIELD OF THE INVENTION

The present invention relates to a method for the care and cleaning of automatic dishwashers, which eliminates grease and limescale deposits in an automatic dishwasher and which together with an automatic dishwasher detergent is usable in a normal dishwashing cycle.

### BACKGROUND OF THE INVENTION

Due to the increasing use of low-temperature, short programs in automatic dishwashers, less grease residue is removed. This may result in an accumulation of these residues. As with limescale deposits, which form inside the dishwasher over time, these grease deposits may impair the rinsing performance and cause defects in the dishwasher. In addition, improper use in the household, for example insufficient removal of food residues from washware, neglecting to clean the machine, underestimating the water hardness, and failure to fill the salt tank for the water softener unit of the machine, may result in grease and/or limescale deposits. The deposits represent not only a technical problem, but also an esthetic problem. Furthermore, food residues and soils, in particular in the screen of the dishwasher, are a breeding ground for undesirable pathogens.

Care agents for removing such deposits are known in the prior art. However, in the normal dishwashing programs for cleaning dishes, the known care agents are not used together with a dishwasher detergent, and instead are generally dosed into the empty dishwasher. This is due to the fact in particular that the known care agents have a very adverse effect on the cleaning action of customary dishwasher detergents. However, to simplify use of such care agents for the consumer, it is desirable to provide care agents that may be used together with a dishwasher detergent in a normal cleaning cycle for cleaning dirty dishes, and thus efficiently keep the interior of the dishwasher free of undesirable grease and limescale deposits without greatly worsening or significantly adversely affecting the cleaning action on the soiled dishes.

It has now been found that care agents that contain at least one nonionic surfactant and at least one acid or a buffer system composed of at least one acid and at least one base, and which have a pH of <6.5 in a 10 wt % solution in water, meet these requirements due to the fact that they have very good grease- and limescale-dissolving properties and do not significantly affect the cleaning power of the dishwasher detergent for the dishes.

### BRIEF SUMMARY OF THE INVENTION

In a first aspect, the present invention is therefore directed to methods for the cleaning and/or care of an automatic dishwasher, in which in a normal cleaning cycle for cleaning dirty washware, using an automatic dishwasher detergent, a care agent for automatic dishwashers that is formulated separately from the dishwasher detergent is added, wherein the care agent contains (a) at least one nonionic surfactant, preferably a fatty alcohol alkoxylate, and (b) at least one acid or a buffer system composed of at least one acid and at least one base, and wherein a 10 wt % solution of the care agent in water at 20° C. has a pH of <6.5, preferably <6.0. This pH is preferably between 4.7 and 6.4, in particular between 5.0 and 6.0, very particularly preferably between 5.0 and 5.6.

In the methods according to the invention, the care agent is used together with an automatic dishwasher detergent in a normal cleaning cycle for cleaning dirty washware, i.e., in the presence of washware to be cleaned (i.e., dishes). This has the advantage that no-load operation of the machine at high water temperatures is avoided. Thus, energy and water are not wasted. In addition, the consumer does not have to empty the machine in everyday operation, and instead may also clean the machine along with the dishes. Routine cleaning of the machine is simplified as a result of this minimal effort for the consumer. In such a case, there is absolutely no accumulation of stubborn soils in the dishwasher, which are removable only under harsh conditions. Furthermore, time, water, and energy are saved due to the simultaneous use of the care agent in the customary dishwashing cycle with washware. In addition, the food residues and soils, in particular in the screen of the dishwasher, which are a breeding ground for undesirable pathogens, are greatly reduced, thus contributing to an improvement in the microbiological condition of the machine.

“At least one,” as used herein, includes but is not limited to 1, 2, 3, 4, 5, 6, or more.

Unless stated otherwise, the expressions in wt % mentioned in the present patent application refer to the active substance content in g, relative to the weight of the overall composition in g.

“Normal cleaning cycle,” as used herein, refers to a program for cleaning washware (dishes) in an automatic dishwasher. Such a cleaning cycle may include one or more pre-rinse steps, one or more main rinse steps, and one or more drying steps. Such a cleaning cycle encompasses the automatic cleaning/rinsing of soiled washware or dishes.

These and further aspects, features, and advantages of the invention are apparent to the person skilled in the art, based on a review of the following detailed description and the claims. Any feature from one aspect of the invention may be used in any other aspect of the invention. In addition, it is understood that the examples contained herein are intended to describe and illustrate the invention, but not to limit same; in particular, the invention is not limited to these examples. Unless stated otherwise, all percentages refer to weight %. Numerical ranges given in the format “from x to y” include the stated values. When multiple preferred numerical ranges are given in this format, it is understood that all ranges that result from the combination of the various end points are likewise included.

### DETAILED DESCRIPTION OF THE INVENTION

The nonionic surfactant used in the care agents described herein may be any nonionic surfactant known to the person skilled in the art. In preferred embodiments, however, nonionic surfactants from the group of alkoxylated alcohols are used. Accordingly, one class of preferably usable nonionic surfactants, which may be used either as a nonionic surfactant alone or in combination with other nonionic surfactants, are alkoxylated, preferably ethoxylated or ethoxylated and propoxylated, fatty alcohols.

In various preferred embodiments, the at least one nonionic surfactant therefore includes a fatty alcohol alkoxylate, in particular a fatty alcohol ethoxylate. In particular, nonend-capped fatty alcohol alkoxylates are preferred.

In preferred embodiments the fatty alcohol ethoxylate has the formula (I)

R¹—O-(EO)ₘ—H (I),

where
R¹ is a linear or branched, substituted or unsubstituted alkyl group having 12 to 24, in particular 14 to 20, in particular 16 to 18, C atoms;
EO is an ethylene oxide unit; and
m is 10 to 50, in particular 20 to 30, preferably 22 to 27, in particular 25.

In particularly preferred embodiments the fatty alcohol ethoxylate has the formula (I)

R¹—O-(EO)ₘ—H (I),

where
R¹ is a linear or branched, substituted or unsubstituted alkyl group having 16 to 18 C atoms;
EO is an ethylene oxide unit; and
m is 20 to 30, preferably 22 to 27, in particular 25.

In one embodiment, the alkyl group R¹ is a linear, preferably unsubstituted, alkyl group having 16 to 18 C atoms.

The fatty alcohol alkoxylate, preferably the fatty alcohol ethoxylate, in particular the fatty alcohol ethoxylate of formula (I), is contained in the care agent in a quantity of 1 to 40 wt %, preferably 2 to 20 wt %, particularly preferably 5 to 15 wt %, relative to the care agent. Such quantities are necessary to ensure sufficient dissolution and removal of grease.

The absolute quantity of the at least one fatty alcohol alkoxylate, preferably fatty alcohol ethoxylate, in particular fatty alcohol ethoxylate of formula (I), in the composition is 0.1 to 4 g/job, preferably 1 to 3 g/job, in particular 1.5 to 2.5 g/job, for example 2 g/job. In the present context, the expression “g/job” means that the care agent contains the stated quantity of fatty alcohol ethoxylate in an amount and form intended for a single use. It has been shown that good results may be achieved in removing grease and limescale in particular with quantities of the care agent of 10 g and greater, typically 10 to 50 g, preferably 15 to 30 g, in particular 20 to 25 g, per use. In various embodiments, the quantity of care agent is such that the care agent lowers the pH of the rinse liquor, preferably by up to 2 units maximum, more preferably to a pH in the range of greater than 7 to less than the pH of the rinse liquor in the absence of the care agent, most preferably to a pH in the range of greater than 8 to less than the pH of the rinse liquor in the absence of the care agent. The phrase “pH of the rinse liquor in the absence of the care agent” refers to the pH of the rinse liquor in the presence of only the automatic dishwasher detergent, but not the care agent according to the invention.

The fatty alcohol alkoxylate, preferably the fatty alcohol ethoxylate, in particular the fatty alcohol ethoxylate of formula (I), is preferably a fatty alcohol ethoxylate that is solid at standard conditions (temperature 25° C., pressure 1013 mbar), and may preferably be used in the form of a powder or granulate.

In various embodiments, the agents described herein contain at least one second fatty alcohol alkoxylate of formula (II)

R²-(AO)_{w}—R³ (II),

where
R² stands for a linear or branched, substituted or unsubstituted alkyl group having 10 to 16 C atoms;
R³ stands for H or a linear or branched hydrocarbon functional group having 2 to 26 carbon atoms;
each A independently stands for a functional group from the group —CH₂CH₂— and —CH₂—CH(CH₃)—, CH₂—CH₂—CH₂—, CH₂—CH₂—CH₂—CH₂—, —CH₂—CH(CH₂—CH₃)—, —CH₂—C(CH₃)₂—, or —CH₂—CH₂—CH(CH₃)—, where at least one A is —CH₂CH₂— and at least one A is —CH₂—CH(CH₃)—, CH₂—CH₂—CH₂—, CH₂—CH₂—CH₂—CH₂—, —CH₂—CH(CH₂—CH₃)—, —CH₂—C(CH₃)₂—, or —CH₂—CH₂—CH(CH₃)—; and
w stands for an integer from 2 to 50, preferably 10 to 30.

In various embodiments, the ratio of the ethylene oxide units to the higher alkylene oxide units in the fatty alcohol alkoxylate of formula (II) is 12:1 to 1:1, preferably 10:1 to 2:1, in particular 6:1 to 3:1. Fatty alcohol alkoxylates of formula (II) in which R² is a linear alkyl group having 12-16 C atoms and R³=H and w=10 to 30 are particularly preferred.

The fatty alcohol alkoxylate of formula (II) is contained in the care agent in particular in a quantity of 0.01 to 3 wt %, preferably 0.1 to 2 wt %, more preferably 1 wt %, relative to the composition. The absolute quantity of the fatty alcohol alkoxylate of formula (II) in the composition is in particular 0.001 to 3 g/job, preferably 0.01 to 1 g/job, more preferably 0.1 to 0.5 g/job, very particularly preferably 0.2 g/job. In various optional embodiments of the invention, the weight ratio of the fatty alcohol alkoxylate, preferably the fatty alcohol ethoxylate, in particular the fatty alcohol ethoxylate of formula (I), to the fatty alcohol alkoxylate of formula (II) is 20:1 to 1:1, preferably 15:1 to 5:1, in particular 10:1.

Combinations of 1 to 18 wt % of a fatty alcohol ethoxylate of formula (I) with 0.1 to 2 wt % of a fatty alcohol alkoxylate of formula (II), in particular combinations of 6 to 13 wt % of a fatty alcohol ethoxylate of formula (I) with 0.1 to 2 wt % of a fatty alcohol alkoxylate of formula (II), for example also 9 to 10 wt % of a fatty alcohol ethoxylate of formula (I) with 0.1 to 2 wt % of a fatty alcohol alkoxylate of formula (II), are preferred. In the combinations mentioned above, it is particularly preferred when the fatty alcohol ethoxylate according to formula (I) has the following parameters: R¹=linear C16-18 alkyl, m=25 and/or the fatty alcohol alkoxylate according to formula (II), where R² is a linear alkyl group having 12-16 C atoms, R³=H, and w=10 to 30.

Also preferred are combinations of 1 to 18 wt % of a fatty alcohol ethoxylate of formula (I) with 0.5 to 1.5 wt % of a fatty alcohol alkoxylate of formula (II), in particular combinations of 6 to 13 wt % of a fatty alcohol ethoxylate of formula (I) with 0.5 to 1.5 wt % of a fatty alcohol alkoxylate of formula (II), for example also 9 to 10 wt % of a fatty alcohol ethoxylate of formula (I) with 0.5 to 1.5 wt % of a fatty alcohol alkoxylate of formula (II). In the combinations mentioned above, it is particularly preferred when the fatty alcohol ethoxylate according to formula (I) has the following parameters: R¹=linear C16-18 alkyl, m=25 and/or the fatty alcohol alkoxylate according to formula (II), where R² is a linear alkyl group having 12-16 C atoms, R³=H, and w=10 to 30.

The fatty alcohol ethoxylate of formula (II) is preferably likewise a fatty alcohol ethoxylate that is solid at standard conditions (temperature 25° C., pressure 1013 mbar), and is preferably also used in the form of a powder or granulate.

The agents described herein may contain at least one further nonionic surfactant. All nonionic surfactants known to the person skilled in the art may be used as nonionic surfactants.

Examples of suitable surfactants are alkyl glycosides of the general formula RO(G)ₓ, in which R corresponds to a primary linear or methyl-branched, in particular methyl-branched in the 2-position, aliphatic functional group having 8 to 22, preferably 12 to 18 C atoms, and G is a symbol that stands for a glycose unit having 5 or 6 C atoms, preferably for glucose. The degree of oligomerization x, which indicates the distribution of monoglycosides and oligoglycosides, is any given number between 1 and 10; x is preferably 1.2 to 1.4.

Another class of usable nonionic surfactants is alkoxylated, preferably ethoxylated or ethoxylated and propoxylated, fatty acid alkyl esters, preferably having 1 to 4 carbon atoms in the alkyl chain.

Nonionic surfactants of the aminoxide type, for example N-cocoalkyl-N,N-dimethylaminoxide and N-tallow alkyl-N,N-dihydroxyethylaminoxide, and the fatty acid alkanolamides may also be suitable. The quantity of these nonionic surfactants is preferably not greater than that of the ethoxylated fatty alcohols, in particular no more than one-half thereof.

Other suitable surfactants are the polyhydroxy fatty acid amides, known as PHFA.

Lastly, further low-foaming nonionic surfactants from the group of alkoxylated alcohols may also be used.

The care compositions described herein also contain pH regulators in the form of at least one acid, or a buffer system that contains at least one acid and at least one base. Furthermore, the pH of the agent may be set in such a way that a 10% solution (w/w) in distilled water at 20° C. has a pH of <6.5, preferably <6.0. This pH is preferably between 4.7 and 6.4, in particular between 5.0 and 6.0, very particularly preferably between 5.0 and 5.6. Organic acids such as citric acid or oxalic acid or the hydrates thereof, very particularly preferably citric acid, are preferred as acid.

Polycarboxylic acids are generally suited as acids, wherein polycarboxylic acids are understood to mean those carboxylic acids bearing more than one acid function. Examples include oxalic acid, citric acid, adipic acid, succinic acid, glutaric acid, malic acid, tartaric acid, maleic acid, fumaric acid, sugar acids, aminocarboxylic acids, and nitrilotriacetic acid (NTA), provided that there are no concerns for their use based on environmental reasons, and mixtures thereof.

Representatives of the aminocarboxylic acids include aspartic acid, methylglycinediacetic acid (MGDA), and glutamine diacetic acid (GLDA) or ethylenediamine diacetic acid. Likewise suitable are imino disuccinate (IDS) and iminodiacetic acid (IDA). However, it is preferred that the acids used are not aminocarboxylic acids.

All bases known in the prior art for dishwasher detergents are suitable bases. However, it is preferred to use the base that corresponds to the acid in the buffer system composed of an acid and a base, for example, use of citrate when citric acid is used as acid. Organic acids and their corresponding bases are therefore preferably used.

The acid or the buffer system composed of an acid and a base is contained in the care agent in a quantity of 1 to 80 wt %, preferably 5 to 60 wt %, particularly preferably 20 to 45 wt %, relative to the care agent, with regard to the particular form that is free of water/water of crystallization. Such quantities are necessary to ensure sufficient descaling.

The absolute quantity of the at least one acid or the buffer system in the composition is 0.2 to 16 g/job, preferably 3 to 10 g/job, particularly preferably 4 to 9 g/job, for example 7 to 8 g/job, with regard to the particular form that is free of water/water of crystallization. When a buffer system composed of an acid and a base is used, the stated quantities refer to the sum of acid and base. For example, 2 to 5 g/job, preferably 2.1 to 4.6 g/job, more preferably 4 to 4.6 g/job, of acid, for example citric acid, and 2 to 5 g/job, preferably 2 to 4 g/job, more preferably 3 to 3.5 g/job, of base, for example citrate, may be used. It is understood that the quantities of acid and base in the buffer system must be selected in such a way that the desired pH range is achieved.

The acid, and optionally also bases, used are preferably solid at standard conditions (temperature 25° C., pressure 1013 mbar), and may preferably be used in the form of a powder, fine crystals, or granulate.

The agents according to the invention may contain at least one further component, preferably selected from the group comprising further surfactants, in particular anionic surfactants, further builders, enzymes, thickeners, sequestering agents, electrolytes, corrosion inhibitors, in particular silver protection agents, glass corrosion inhibitors, foam inhibitors, dyes, fragrances, bitterns, and antimicrobial active ingredients.

In preferred embodiments the agent is phosphate- and/or phosphonate-free. In other preferred embodiments the agent is free of bleaching agent. “Phosphate-free” and “phosphonate-free,” as used herein, means that the composition in question is essentially free of phosphates or phosphonates, i.e., in particular contains phosphates or phosphonates in quantities of less than 0.1 wt %, preferably less than 0.01 wt %, relative to the overall composition. It is preferred that the total quantity of phosphorus does not exceed 0.3 g, preferably 0.03 g, per job.

Preferred anionic surfactants are fatty alcohol sulfates, fatty alcohol ether sulfates, dialkyl ether sulfates, monoglyceride sulfates, alkylbenzenesulfonates, olefin sulfonates, alkane sulfonates, ether sulfonates, n-alkyl ether sulfonates, ester sulfonates, and lignin sulfonates. Likewise usable within the scope of the present invention are fatty acid cyanamides, sulfosuccinates (sulfosuccinic acid esters), in particular sulfosuccinic acid mono- and dialkyl esters having 8 to 18 C atoms, sulfosuccinamates, sulfosuccinamides, fatty acid isethionates, acylaminoalkanesulfonates (fatty acid taurides), fatty acid sarcosinates, ethercarboxylic acids, and alkyl(ether) phosphates, as well as α-sulfofatty acid salts, acylglutamates, monoglyceride disulfates, and alkyl ethers of glycerin disulfate.

The anionic surfactants are preferably used as sodium salts, but may also be contained as other alkali metal or alkaline earth metal salts, for example potassium or magnesium salts, as well as in the form of ammonium salts or mono-, di-, tri-, or tetraalkylammonium salts, and in the case of the sulfonates, also in the form of their corresponding acid, for example dodecylbenzenesulfonic acid.

Further usable builders include carbonates and silicates; when they are used in the formulation, the quantity of acid or of the buffer system with regard to buffer capacity and pH should be appropriately taken into account.

For example, it is possible to use carbonate(s) and/or hydrogen carbonate(s), preferably alkali carbonate(s), particularly preferably sodium carbonate. In various embodiments of the invention, alkali carbonates, in particular sodium carbonate, are preferably contained in a quantity of 0 to 15 wt %, preferably 0 to 10 wt %, relative to the care agent/the composition.

The agents may also contain crystalline phyllosilicates of the general formula NaMSiₓO₂ₓ₊₁⋅H₂O as builders, where M represents sodium or hydrogen, x stands for a number from 1.9 to 22, preferably from 1.9 to 4, and particularly preferred values for x are 2, 3, or 4, and y stands for a number from 0 to 33, preferably from 0 to 20. Also usable are amorphous sodium silicates having an Na₂O:SiO₂ modulus of 1:2 to 1:3.3, preferably 1:2 to 1:2.8, and in particular 1:2 to 1:2.6, and which preferably dissolve with delay and have secondary wash properties. In preferred agents, the silicate content, relative to the total weight of the dishwasher detergent, is limited to quantities less than 10 wt %, preferably less than 5 wt %, and in particular less than 2 wt %. Particularly preferred agents are silicate-free.

Within the scope of the present invention, individual odorant compounds, for example the synthetic products of the ester, ether, aldehyde, ketone, alcohol, and hydrocarbon type, may be used as perfume oils or fragrances. However, it is preferred to use mixtures of various odorants which together produce a pleasant scent. Such perfume oils may also contain natural odorant mixtures available from plant sources, such as pine, citrus, jasmine, patchouli, rose, or ylang-ylang oils.

The care agents described herein may be provided in various ways. The agents may be present in solid or liquid product forms as well as a combination of solid and liquid product forms. In particular powders, granulates, extrudates, compactates, especially tablets, are particularly suited as solid product forms. The liquid product forms based on water and/or organic solvents may be present in thickened form as gels.

In preferred embodiments the care agent is present in a solid product form.

In the present context, “solid” means that the composition is present in solid form at standard conditions (temperature 25° C., pressure 1013 mbar). In various embodiments, the at least one surfactant and/or the at least one acid or the buffer system are/is present in the solid state at 25° C. (pressure 1013 mbar), for example as a powder or granulate, and when processed with the other components of the solid care agent do/does not reduce the pourability of the produced care agent, and may therefore be incorporated in any desired quantities.

The agents described herein are preferably pre-prepared in dosing units. These dosing units preferably include the quantity of washing- or cleaning-active substances necessary for one cleaning operation. Preferred dosing units have a weight between 10 and 50 g, preferably between 20 and 30 g, and in particular 25 g. To achieve an optimal cleaning result, means are preferred which are present in the form of a pre-prepared dosing unit. The volume of the above-mentioned dosing units and their shape may be selected so that the dosing of the pre-prepared units cannot take place via the dosing chamber of a dishwasher, but, rather, the unit must be added directly into the interior of the dishwasher.

The agents and compositions described herein may have a water-soluble wrapping. The pre-prepared dosing units are particularly preferably formed by a water-soluble wrapping of an appropriate portion quantity of composition according to the invention; thus, the pre-prepared dosing unit preferably includes an agent according to the invention as well as water-soluble wrapping/packaging.

The water-soluble wrapping is preferably formed from a water-soluble film material that is selected from the group comprising polymers or polymer mixtures. The wrapping may be formed from one, two, or more layers of the water-soluble film material. The water-soluble film material of the first layer and of the additional layers, if present, may be the same or different. Films that may be glued and/or sealed to form packagings such as tubes or cushions after they have been filled with an agent are particularly preferred.

The water-soluble wrappings/packagings are preferably thermoformed or injection-molded articles.

The water-soluble containers/wrappings/packagings may also be produced by injection molding. Injection molding refers to the shaping of a molding compound in such a way that the compound contained in a compound cylinder for more than one injection molding operation is plastically softened under the action of heat, and under pressure flows through a die into the cavity of a mold that has been closed beforehand. The method is used primarily for noncurable molding compounds that solidify in the mold by cooling. Injection molding is a very cost-efficient, modern method for producing articles by non-cutting shaping, and is particularly suited for automated mass production. In practical operation, the thermoplastic molding compounds (powders, grains, cubes, pastes, among others) are heated to liquefaction (up to 180° C.) and are then injected under high pressure (up to 140 MPa) into closed, two-part (i.e., made up of a cavity (formerly “matrix”) and a core (formerly “die”)), preferably water-cooled hollow molds, where they cool and solidify. Piston injection molding machines and screw injection molding machines may be used.

Such molded bodies may likewise have one, two, three, or more chambers and may be filled with liquid and/or solid compositions, one of which is one of the compositions according to the invention. For example, it is possible to close the chambers on the open side, either with a second molded body or with one or more water-soluble films (in particular as described herein). The release of the compositions present in the chambers may thus be arbitrarily controlled according to the desired release time, either all at once (directly at the beginning of the cleaning cycle or at a certain time in the course of the cleaning cycle), or by varying the film composition at certain different times within the dishwasher cycle (for example, as a function of the temperature of the rinse water).

It is preferred that the water-soluble wrapping contains polyvinyl alcohol or a polyvinyl alcohol copolymer. Water-soluble wrappings containing polyvinyl alcohol or a polyvinyl alcohol copolymer have good stability with sufficiently high water solubility, in particular cold water solubility.

Suitable water-soluble films for producing the water-soluble wrapping are preferably based on a polyvinyl alcohol or a polyvinyl alcohol copolymer whose molecular weight is in the range of 10,000 to 1,000,000 gmol⁻¹, preferably 20,000 to 500,000 gmol⁻¹, particularly preferably 30,000 to 100,000 gmol⁻¹, and in particular 40,000 to 80,000 gmol⁻¹.

Polyvinyl alcohol is typically produced by hydrolysis of polyvinyl acetate, since the direct synthesis pathway is not possible. The same applies for polyvinyl alcohol copolymers correspondingly prepared from polyvinyl acetate copolymers. It is preferred when at least one layer of the water-soluble wrapping includes a polyvinyl alcohol having a rate of hydrolysis of 70 to 100 mol %, preferably 80 to 90 mol %, particularly preferably 81 to 89 mol %, and in particular 82 to 88 mol %.

In addition, a polymer selected from the group comprising (meth)acrylic acid-containing (co)polymers, polyacrylamides, oxazoline polymers, polystyrene sulfonates, polyurethanes, polyesters, polyethers, polylactic acid, or mixtures of the above polymers may be added to the polyvinyl alcohol-containing film material that is suitable for producing the water-soluble wrapping. Polylactic acids are one preferred additional polymer.

In addition to vinyl alcohol, preferred polyvinyl alcohol copolymers include dicarboxylic acids as further monomers. Suitable dicarboxylic acids are itaconic acid, malonic acid, succinic acid, and mixtures thereof, with itaconic acid being preferred.

Likewise preferred polyvinyl alcohol copolymers include, in addition to vinyl alcohol, an ethylenically unsaturated carboxylic acid, the salts thereof, or the esters thereof. In addition to vinyl alcohol, such polyvinyl alcohol copolymers particularly preferably contain acrylic acid, methacrylic acid, acrylic acid ester, methacrylic acid ester, or mixtures thereof.

It may be preferred that the film material contains further additives. The film material may contain, for example, plasticizers such as dipropylene glycol, ethylene glycol, diethylene glycol, propylene glycol, glycerin, sorbitol, mannitol, or mixtures thereof. Additional additives include, for example, release aids, filling agents, crosslinking agents, surfactants, antioxidants, UV absorbers, antiblocking agents, non-stick agents, or mixtures thereof.

Suitable water-soluble films for use in the water-soluble wrappings of the water-soluble packagings according to the invention are films marketed by Firma MonoSol LLC, for example under the names M8630, C8400, or M8900. Other suitable films include those with the names Solublon® PT, Solublon® GA, Solublon® KC, or Solublon® KL from Aicello Chemical Europe GmbH, or the VF-HP films from Kuraray.

Use of the care agent according to the invention in a water-soluble wrapping has the advantage that, in contrast to the customary bottles that are closed with a wax seal which dissolves only at high water temperatures, the preportioned dosing units may be released at lower temperatures, and therefore, also possibly earlier in the course of the cleaning process or in the rinse cycle. Such a preportioned dosing unit also generally takes up less space than one of the customary bottles used heretofore, which must be either suspended in the machine or placed in the cutlery basket. In addition, the preportioned dosing unit may be placed at any desired location inside the dishwasher.

In the methods according to the invention, the care agent according to the invention may be dosed into the interior of a dishwasher prior to or during a dishwashing program (in the presence of washware to be cleaned, in particular dirty dishes), either before or during the main rinse cycle. The dosing or the introduction of the agent according to the invention into the interior of the dishwasher may take place manually. In various embodiments, the care agent is directly dosed into the interior of the automatic dishwasher at the beginning of the cleaning cycle, preferably before the automatic dishwasher detergent. The dosing of the care agent into the interior of the dishwasher preferably takes place prior to or at the beginning of the rinse cycle, and before the automatic dishwasher detergent is dosed via the dosing chamber at the beginning of the main rinse cycle.

The method according to the invention, using a care agent according to the invention, may be used with programs that are possible in all standard dishwashers, in particular home dishwashers. In preferred methods, however, low-temperature dishwashing programs are used. They are used in the household for dishwashing in order to save energy. Such programs generally have nominal rinse temperatures of typically 45 to 55° C.

In one preferred embodiment of the method according to the invention, the method is characterized in that in the course of the method, the temperature of the cleaning liquor in the main rinse cycle increases to values less than 70° C., preferably values less than 60° C., and preferably to temperatures between 30 and 58° C., preferably to temperatures between approximately 40° C. and approximately 55° C.

### EXAMPLES

### Example 1: Influence of the Cleaning Power of a Multifunction Dishwasher Detergent Tablet

The following formulation was mixed:

| | % | g/job |
|---|---|---|
| C₁₃-C₁₅ FAEO with EO/BuO | 2.62 | 0.55 |
| C₁₆₋₁₈ FAEO with 25 EO | 9.52 | 2.00 |
| Sodium citrate, water-free | 46.38 | 9.74 |
| Citric acid monohydrate | 19.52 | 4.10 |
| Soda | 8.00 | 1.68 |
| Sodium sulfate | 10.85 | 2.28 |
| PEG 4000 | 3.00 | 0.63 |
| Fragrance | 0.10 | 0.02 |
| Total | 100.0 | 21.0 |

In a test for determining the cleaning power according to the IKW method (Miele 698, 50° C., 3 min. retention time, 21° dH), in each run, in addition to the conventional cleaner (Somat 7), 21 g of the formulation was dosed into the bottom of the machine immediately before starting the program. A comparative test was carried out under identical conditions, but without addition of the formulation.

A difference of more than one unit was considered to be a significant difference in the cleaning power. The following cleaning powers were determined:

| | BOP tea | Ground meat | Starch |
|---|---|---|---|
| Without | 4.8 | 9.1 | 8.4 |
| care agent | | | |
| With | 4.8 | 8.8 | 8.4 |
| care agent | | | |

None of the tested soils showed significant losses in the cleaning power. In particular, the bleachable soils (tea) and the amylase sensitive soils (spaghetti, starch) remained at the original performance level.

### Example 2: Formulations

| | E1 | | E2 | | E3 | | E4 | |
|---|---|---|---|---|---|---|---|---|
| | | g/job | % | g/job | % | g/job | % | g/job |
| C₁₃—C₁₅ FAEO with | 2.62 | 0.55 | | | | | | |
| EO/BuO | | | | | | | | |
| C₁₆₋₁₈ FAEO with 25 | 9.52 | 2.00 | 9.52 | 2.00 | 9.52 | 2.00 | 9.52 | 2.00 |
| EO | | | | | | | | |
| Na citrate, water-free | 46.38 | 9.74 | 24.38 | 5.12 | 17.40 | 3.66 | 16.86 | 3.54 |
| Citric acid, water-free | | | 15.00 | 3.15 | 22.00 | 4.62 | 22.00 | 4.62 |
| Polyacrylate | | | 21.00 | 4.41 | 21.00 | 4.41 | 21.00 | 4.41 |
| homopolymer | | | | | | | | |
| granulate, 90% | | | | | | | | |
| active matter | | | | | | | | |
| Citric acid | 19.52 | 4.10 | | | | | | |
| monohydrate | | | | | | | | |
| Soda | 8.00 | 1.68 | 8.00 | 1.68 | 8.00 | 1.68 | 8.00 | 1.68 |
| Sodium sulfate | 10.85 | 2.28 | | | | | | |
| Filler without power | | | 22.00 | 4.62 | 22.00 | 4.62 | 22.52 | 4.68 |
| PEG 4000 | 3.00 | 0.63 | | | | | | |
| Fragrance | 0.10 | 0.02 | 0.10 | 0.02 | 0.10 | 0.02 | 0.10 | 0.02 |
| Total | 100.0 | 21.0 | 100.0 | 21.0 | 100.0 | 21.0 | 100.0 | 21.0 |

### Example 3: pH Values

Formulations E2 and E3 were mixed, and the pH of a 10% solution in distilled water was determined:
E2: (water) pH 5.78
E3: (water) pH 4.96

Formulation E4 was tested in an analogous manner, with the further addition of 21 g of the formulation to the bottom of the dishwasher interior, loaded with a Somat 7 tablet (Henkel) in the dosing compartment, and the pH of the rinse liquor was measured immediately after the machine cleaner formulation dissolved in the rinse water, and subsequently the pH of the rinse liquor was measured after the Somat 7 tablet dissolved.

10%: pH 5.2
Immediately after dissolving: pH 6.06
After the tablet dissolved: pH 8.83

### Example 4: Grease Removal

To determine the performance of a care agent with respect to grease, the filter of the automatic dishwasher was initially soiled with grease in order to subsequently determine the performance of the care agent in this soiled machine:

### Machine: Bosch SMS 86M12

Grease soil: 5 g butter+5 g margarine
Product: A standard automatic dishwasher cleaner that allowed the desired grease buildup in fewer than 10 cycles. For example, formulations having a sufficient quantity of drying surfactant are suitable.

Prior to the run, the (two-part) filter was weighed dry. The grease soil was added directly into the upper shelf of the machine, and the dishwasher cleaner was placed in the dosing compartment. A cycle with the “Glass 40° C.” program was then run. The filter was subsequently removed, the remaining water was allowed to drain off for 30 min, and the quantity of grease buildup was determined using a scale. The procedure was repeated until a grease mass of approximately 10 g had built up.

The soiled filter was then placed back in the machine, the dishwasher cleaner was added to the dosing compartment and the care agent formulation to be tested was added at the bottom of the washing, and a “Glass 40° C.” program was run. The filter was once again removed, and after draining for 30 min was weighed. The quantity of grease removed by the product was thus determined, and the quantity of grease still remaining was expressed as % of the original quantity of grease.

Formulation E4 (21 g) was tested with various commercially available dishwasher detergents. The remaining quantity of grease with use of the care agent was 23-32% lower than the remaining quantity of grease without the care agent.

### Example 5: Descaling

Marble plates having dimensions of approximately 15 cm by 7.5 cm and a thickness of approximately 0.5 cm were washed in a dishwasher under specified conditions. The removal, i.e., the limescale dissolving capacity, was subsequently determined by back-weighing. Suitable plates may be obtained, for example, from Naturstein Kohlenberg, Dusseldorf, Germany as IPP test plates made of Bianco Carrara “CD” marble in a 150/75/5 mm size. Coarse soiling and dust were removed from the marble plates using a dry cloth. The plates were then rinsed with ethanol and wiped off once more with a dry, clean cloth, and dried in air for approximately 5 min. The plates were then marked by engraving and weighed on an analytical balance.

In each case three marble plates were placed in the top shelf of the dishwasher. The machine cleaner to be tested was added at the bottom of the washing compartment, and the wash program (50° C.) was started. After the program ended, the marble plates were dried in a drying oven for 2 hours at 105° C. After complete cooling, the limescale dissolving capacity of the machine cleaner was determined by back-weighing.

The following formulations were tested:

| | E5 | E6 | E7 | E8 | E9 |
|---|---|---|---|---|---|
| C₁₆₋₁₈ FAEO with 25 EO | 9.52 | 9.52 | 9.52 | 9.52 | 9.52 |
| Fillers without descaling or | 22.50 | 22.50 | 22.50 | 22.50 | 22.50 |
| grease removal power | | | | | |
| Polyacrylate homopolymer | 21.00 | 21.00 | 21.00 | 21.00 | 21.00 |
| granulate, 90% active | | | | | |
| matter | | | | | |
| Red soda | 8.00 | 8.00 | 8.00 | 8.00 | 8.00 |
| Citric acid, water-free | 22.00 | 15.00 | 10.00 | 7.50 | 5.00 |
| Na citrate, water-free | 16.88 | 23.88 | 28.88 | 31.38 | 33.88 |
| Fragrance | 0.10 | 0.10 | 0.10 | 0.10 | 0.10 |
| Total | 100.00 | 100.00 | 100.00 | 100.00 | 100.00 |
| pH, 10% in water | 5.12 | 5.62 | 5.98 | 6.54 | 7.58 |
| Lime removal (% of | 100 | 14.7 | 7.0 | 0 | 0 |
| maximum value) | | | | | |

What is claimed is:

1. A method for the cleaning of an automatic dishwasher, where in a normal cleaning cycle for cleaning washware using an automatic dishwasher detergent, a care agent for automatic dishwashers that is formulated separately from the dishwasher detergent is added, wherein the care agent contains (a) at least one nonionic surfactant and (b) at least one acid or a buffer system composed of at least one acid and at least one base, and wherein a 10 wt % solution of the care agent in water at 20° C. has a pH of <6.5.

2. The method according to claim 1, wherein at least one nonionic surfactant is a fatty alcohol ethoxylate of the formula (I)
R¹—O-(EO)ₘ—H (I),
where
R¹ is a linear or branched, substituted or unsubstituted alkyl group having 12 to 24 C atoms;
EO is an ethylene oxide unit; and
m is 10 to 50.

3. The method according to claim 1, wherein the at least one nonionic surfactant is contained in a quantity of 1 to 40 wt % relative to the care agent, and the absolute quantity of the at least one nonionic surfactant in the composition is 0.1 to 4 g/job.

4. The method according to claim 1, wherein (a) the at least one acid is an organic acid or (b) the buffer system is composed of at least one organic acid and the corresponding base.

5. The method according to claim 1, wherein the at least one acid or the buffer system composed of at least one acid and at least one base is contained in a quantity of 1 to 80 wt % relative to the care agent, and the absolute quantity of the at least one acid or of the buffer system in the composition is 0.2 to 16 g/job.

6. The method according to claim 1, wherein the care agent
(a) is present in solid form; and/or
(b) is present in preportioned form; and/or
(c) is present in a water-insoluble, water-soluble, or water-dispersible packaging, and
(d) is used in a quantity of 10 to 50 g/job.

7. The method according to claim 1, wherein the care agent is phosphate-free and/or phosphonate-free.

8. The method according to claim 1, wherein the care agent/the composition includes at least one further component selected from the group consisting of further builders, further surfactants, polymers, enzymes, corrosion inhibitors, glass corrosion inhibitors, disintegration agents, fragrances, and perfume carriers.

9. The method according to claim 1, wherein the care agent lowers the pH of the rinse liquor by up to 2 units.

10. The method according to claim 1, wherein the care agent is dosed into the interior of the automatic dishwasher at the beginning of the cleaning cycle.

11. The method according to claim 1, wherein in a normal cleaning cycle for cleaning dirty dishes using an automatic dishwasher detergent, a care agent for automatic dishwashers that is formulated separately from the dishwasher detergent is added, wherein the care agent contains (a) a fatty alcohol alkoxylate and (b) at least one acid or a buffer system composed of at least one acid and at least one base, and wherein a 10 wt % solution of the care agent in water at 20° C. has a pH of <6.0.

12. The method according to claim 1, wherein the care agent contains (a) a fatty alcohol alkoxylate and (b) at least one acid or a buffer system composed of at least one acid and at least one base, and wherein a 10 wt % solution of the care agent in water at 20° C. has a pH of 5.0-5.6.

13. The method according to claim 2, wherein at least one nonionic surfactant is a fatty alcohol ethoxylate of the formula (I)
R¹—O-(EO)ₘ—H (I),
where
R¹ is a linear or branched, substituted or unsubstituted alkyl group having 14 to 20 C atoms;
EO is an ethylene oxide unit; and
m is 20 to 30.

14. The method according to claim 2, wherein at least one nonionic surfactant is a fatty alcohol ethoxylate of the formula (I)
R¹—O-(EO)ₘ—H (I),
where
R¹ is a linear or branched, substituted or unsubstituted alkyl group having 16 to 18 C atoms;
EO is an ethylene oxide unit; and
m is 22 to 27.

15. The method according to claim 2, wherein at least one nonionic surfactant is a fatty alcohol ethoxylate of the formula (I)
R¹—O-(EO)ₘ—H (I),
where
m is 25.
